(19) United States
(12) Patent Application Publication
(10) Pub. No.: US 2003/0015965 A1
(43) Pub. Date: Jan. 23, 2003

(54) Inductively coupled plasma reactor

(76) Inventor: Valery Godyak, Brookline, MA (US)

Correspondence Address: PERKINS, SMITH & COHEN LLP, ONE BEACON STREET, 30TH FLOOR, BOSTON, MA, 02108, US

(21) Appl. No.: 10/204,043

(22) PCT Filed: Dec. 21, 2001
(86) PCT No.: PCT/US01/49203

(51) Int. Cl. H01J 7/24

(52) U.S. Cl. 315/111.21; 315/111.51

(57) ABSTRACT

An inductively coupled plasma source with one or more sets of chamber (202a, 202b) compartments divided (completely or partially) by a flat casing (204a, 204b) including encased toroidal ferromagnetic inductors (206, 208) with the induced discharge current passing between the divided sub-chambers in closed loops through passages in such toroidal ferromagnetic inductors (206, 208). The chamber has a gas inlet (222) and an outlet (223) for flowing the working gas mixture.

### CROSS REFERENCE TO CO-PENDING APPLICATION

This application has priority from U.S. provisional application Serial No. 60/257,786 filed Dec. 26, 2000 by Valery Godyak, one of the present inventors, entitled PLASMA REACTOR FOR LARGE SCALE PLASMA PROCESSING.

### FIELD OF THE INVENTION

The preset invention is related to a rf (radio frequency) plasma sources, also known as plasma reactors, driven by ferromagnetic core inductors, for variety of tasks in plasma processing technology (plasma etching, deposition, dissociating, abatement, plasma sterilization, ion implantation and so on) and having features of plasma uniformity self-control, over a large processing area.

### BACKGROUND OF THE INVENTION

RF inductive plasma reactors, or inductively coupled plasma (ICP) sources, are commonly recognized as the most advanced, convenient and cost effective way of plasma generation for different applications in plasma processing technology for large-scale manufacturing of semiconductor chips (etching, deposition, ion implantation, sputtering) and large panel displays. Such sources are also used for generation of activated gases used for cleaning plasma-processing chambers and for incineration (abatement) of harmful plasma processing gases, [M. A. Lieberman and A. J. Lichtenberg, “Principles of Plasma Discharges and Materials Processing”, John Wiley & Sons, Inc, New York, 1994]. Application of inductive discharges has an advantage of achieving high density plasma in a wide range of gas pressure with maximal energy transfer to the plasma electrons rather than to the plasma ions as is typical in capacitevily coupled rf discharges.

A typical ICP for large area uniform plasma processing of 300 mm wafers and flat panel displays consists of a cylindrical metal chamber filled with working gas and having a flat quartz window between a flat inductor coil and plasma chamber housing a processed wafer. The operation of this ICP (as any inductive discharge) is based on the principle of electromagnetic induction. The rf current driven in the inductor coil induces electromagnetic rf field and rf plasma current in the chamber, thus maintaining a plasma discharge there. As any inductive rf discharge this ICP plasma source can be considered as an electrical transformer where the inductor coil connected to an rf source is an actual primary winding and the plasma is a single closed turn of a virtual secondary winding.

A very common problem in ICPs operated at industrial frequency of 13.56 MHz, is a relatively high if power loss in the inductor coil carrying tens of amperes of rf current and few KV of if voltage. Additionally, a considerable rf current is usually induced along the metal chamber wall. This results in chamber heating and in an additional rf power loss there.

Also, a significant problems in industrial ICP for plasma processing arises due to very high rf voltage present on the inductor coil leading to considerable capacitive coupling between the coil and plasma. The non-linear interaction of rf field with the plasma sheath on the inner surface of the quartz window creates a high negative dc potential there. This negative potential accelerates the plasma ions towards the window causing its erosion and sputtering, leading to plasma contamination.

Another problem in the conventional ICP sources with a flat induction coil, is a relatively large radial and azimuthal plasma non-uniformity. The first is due to plasma diffusion to the wall and due to non-uniform radial distribution of rf electric field created by the coil. The azimuthal plasma non-uniformity is caused by the transmission line effect along the coil conductor. This effect results in the coil current non-uniformity along the coil wire, thus leading to the plasma azimuthal non-uniformity. The transmission line effect is an increasing problem for large rf plasma reactors when the coil wire length becomes comparable to the wave length of the working frequency.

To improve plasma radial uniformity and inductor coil efficiency Okumura and Nakayama [Rev. Sci. Instrum. 66, 5262, 1995] have proposed an inductor coil structure operating at 13.56 MHz and consisting of four spiral coils connected in parallel in a vortex shape. Their coil structure has improved ICP efficiency and reduced the capacitive coupling, but has generated an increased azimuthal non-uniformity. Moreover, driving ICP by parallel connected inductors has trends to development of plasma instability bringing to even more plasma inhomogeneity in both, azimuthal and radial directions.

Heinrich et all [J. Vac. Sci. Technol. B 14, 2000, 1996] have proposed to increase the plasma uniformity by replacing of a single large inductor coil with plurality of relatively small coils. In their ICP etching reactor the plasma was energized by four inductor coils wound on four separate short quartz tube placed on the chamber top. The inductor coils were driven in parallel at 13.56 MHz from a common rf power source. Energizing plasma by four separated in space inductor coils resulted in increase of the plasma uniformity comparing to that in ICP with a single coil operation. A similar approach to increase plasma uniformity in ICP operated at 27.12 MHz has been used by Chen et al, [Plasma Sources Sci. Technol. 10, 236, 2001] by symmetrically distributing of seven small helicon plasma sources on the chamber top.

In these referred proposals the inductor coils are working in parallel. Such an operation of gas discharge plasma requires a very careful symmetry adjustment to make all coils operate identically. But the fundamental problem limiting practical implementation of the mentioned proposals steams out from an attempt to drive gas discharge by parallel connected energy sources. Due to inherent to gas discharge plasma a negative current-voltage characteristic, the driving of a discharge by parallel means (such as plurality of cathodes and anodes or plurality of rf electrodes or inductors) leads to the plasma instability. This instability manifests itself as a trend to a single electrode or a single inductor operation, thus resulting in an enormous plasma non-uniformity.

RF plasma sources operating at standard frequency of 13.65 MHz require expensive rf power sources. As a rule, they also require complicated matching-tuning networks with expensive vacuum high-frequency variable capacitors and electromechanical drivers. Operation of such matchers requires simultaneous adjusting for matching and tuning function that additionally requires an incorporating of rf sensors and automatic control electronics. High costs of the components in rf plasma sources operating at 13.56 MHz make such system to be very expensive and encourage search for alternative solutions.

This alternative approach for inductively coupled plasma came from plasma fusion technology developed long before plasma processing of semiconductor materials. In the 1960^{th} a family of toroidal plasma sources like Tokamak and Stelarator were developed for confinement of hot plasma in hope for controlled nuclear fusion. See, for example, F. F. Chen, “Introduction to Plasma Physics and Controlled Fusion”, Plenum, New York, 1984. In these devices, the toroidal plasma was driven as a closed upon itself secondary winding of a ferromagnetic core inductor (transformer) which primary winding was connected to an electrical power source.

Low temperature toroidal plasma devices (similar to Tokamak and Stelarator) driven with ferrite core, have been proposed for lighting as an electrodeless rf lamp by J. M. Anderson [U.S. Pat. No. 3,500,118] and as a remote plasma source for dissociation of gases by A. R. Reinberg et al, [U.S. Pat. No. 4,431,898], by C. B. Zarovin and R. L. D. Bollinger, [U.S. Pat. No. 5,290,382] and by D. K. Smith et al, [U.S. Pat. No. 6,150,628]. In all these patents, inductively coupled plasma was confined in dielectric or metallic toroidal chamber penetrating a ferrite core transformer with its primary winding being connected to rf power source. Utilization of closed ferrite cores in these plasma sources has drastically increased the coupling of the primary winding with plasma that resulted in increase of the power transfer efficiency and allowed to considerably reduce the operating frequency to the range of hundred kHz instead of 13.56 MHz typical for conventional ICP. This reduction in operating frequency has led to considerable cost reduction of RF power source and has eliminated the need of complicated tuning-matching networks necessary for ICP operation at 13.56 MHz.

The various apparatus forms described above, and documented in U.S. Pat. No. 4,431,898; 5,290,382 and 6,150,628, are applicable for volume plasma processing such as gas dissociation, abatement and similar, but are unsuitable for uniform large surface plasma processing. To achieve uniform plasma over large area, Ogle, [U.S. Pat. No. 5,435,881] proposed to replace the flat spiral inductor coil of traditional 13.56 MHz ICP source, by multiple of U-shape open ferrite cores having their primary windings connected to 13.56 MHz rf power source. Ferrite inductors have maintained small inductive discharges evenly spread over the window providing good plasma uniformity. Conceptually this approach is similar to that already considered by Heinrich et all [J. Vac. Sci. Technol. B 14, 2000, 1996] and by Chen et al, [Plasma Sources Sci. Technol. 10, 236, 2001].

Another approach utilizing ferrite core inductors for producing of uniform plasma was considered by E. Shun'ko, [U.S. Pat. No. 5,998,933]. There, ICP source has a closed ferrite core immersed into a discharge chamber filled with a working gas. The ferrite inductor induces rf electric field and rf discharge current path surrounding the magnetic path of the ferrite core, thus maintaining plasma in the discharge chamber. To prevent the ferrite inductor from erosion and overheating by surrounding dense plasma, the inductor is encapsulated into a metal jacket with air or water-cooling. A multiple ferrite inductors having ring or rectangular shape, distributed over the discharge chamber was proposed in this patent [U.S. Pat. No. 5,998,933] to obtain uniform plasma processing over a large substrate area. The way to mechanically support of each individual ferrite inductor using the primary coil leads, and individual cooling of each inductors with force air or water flow makes the proposed in this patent plasma sources too complicated and impractical.

Inductive plasma sources having multiple inductors (with or without ferrite core) of the types described above require (for practical implementation) multiple individual if sources or individual matching devices with precise adjusting and control rf power delivered to each inductor. Parallel driving of multiple inductors with a single if power source and a single matcher-tuning network provides a tendency to plasma instability that finally evolves to large plasma non-uniformity. The proposals of ICP with multiple of inductors of the types described above imply an individual cooling of each inductor by water flow in copper tubes forming the multiple coils or surrounding ferrite inductors. Cooling of inductor coils (having high rf potential) by grounded tap water requires an rf decoupling means that brings additional complexity and cost in plasma processing ICP sources.

### SUMMARY OF THE INVENTION

The objects of the present invention are:

(a) to provide a low frequency if plasma source advantageous for both, volume and uniform surface plasma processing;

(b) to provide such a source having one or more of the features of plasma uniformity self-control, and eliminating capacitive coupling and transmission line effect;

(c) to provide such a source having features of being self-starting, having simple and effective inductor cooling, yet having simple construction and being inexpensive to manufacture.

The above objects are achieved by means an rf plasma reactor (see FIGS. 1 and 2 cited below) which comprises, for example,

(a) a sealed vacuum chamber,

(b) divided into two compartments by a flat casing encapsulating a plurality, e.g., a pair, of toroidal ferromagnetic cores inductors having their primary winding connected to a power source; and

(c) a programmable RF power source.

The inductor cores may be coplanar and arranged side by side. The chamber compartments are connected through the holes of the toroidal cores for closing the rf discharge current paths and passing flows of the working gas.

Plasma reactors of the invention utilize the general principle of inductive discharge where the discharge plasma itself forms a virtual single turn secondary winding. When the inductors are energized via their primary windings, they induce rf electromotive forces (emf) having opposite directions in neighboring ferrite inductors, thus generating closed-path plasma currents flowing within the half-chambers through the holes of each of the toroidal core inductors.

Encapsulating the ferrite core inductors inside a common flat solid thermo-conductive inductor casing (that is attached to the discharge chamber), leads to considerable simplification of the plasma source construction and simultaneously provides effective ferromagnetic inductor cooling. Due to high thermo-conductivity of the inductor casing (made of metal or of thermo-conductive dielectric) an effective inductor cooling can be arranged on the periphery of the casing using water flow in adjusted copper tubes.

A multiple-stage plasma source with two or more inductor casings dividing the plasma chamber into three or more compartments (as shown in FIG. 4) provides larger plasma volume (and thus, plasma reaction rate) than with a single inductor casing and two compartments, or can be used for diversifying plasma reactions in different compartments by supplying different if power to different inductor casing and/or by having different gas mixtures in different compartments. Thus, stacking different number of inductor casings (holders) and chamber compartments with programmable rf power supply to different inductor holder, one can build plasma source able to process simultaneously several plasma-chemical reactions.

To assure plasma source stable operation (caused by line voltage or/and gas pressure instabilities) and to provide the working gas breakdown with a fast transition to inductive mode, the primary windings of the ferrite core inductors are connected to an rf power-switching source via parallel resonant matching circuit (shown in FIG. 3) operating as a rf current source. Also, the primary winding and/or an additional starting winding wound on the same ferrite core is connected to the starting electrode. When, with no plasma, rf power source switches on, a high voltage develops on the primary (or/and additional) winding of unloaded ferrite inductor and a large circular electromotive force (emf) develops across ferrite inductor. This simultaneous jump of the rf voltage on the starting electrode and of the inductive emf provides a fast plasma density build-up for normal operational of the plasma source.

According to another embodiment of the present invention, shown in FIG. 7, a plurality of ferrite inductor pairs, evenly distributed inside the inductor casing, induce multiple of the closed-path if currents evenly distributed in both chamber compartments, thus providing an uniform plasma distribution along the both sides of the inductor casing and in both chamber compartments with processing wafer. Generation of uniform plasma on the both sides of the inductor casing, in both chamber compartments, (allowing for two-side wafer processing) is an attractive feature of the proposed plasma source.

Although, rf currents, induced in the plasma by each of the inductor pairs are flowing in parallel, it does not lead to plasma spatial instability. The plasma stabilization in the plasma reactor of the invention is achieved by electromagnetic coupling of neighboring inductors with common discharge current path, penetrating neighboring inductors, (cooperative operation) and by connection of the primary windings of inductors, in series to the rf power source. Due to strong coupling between the primary windings to plasma (provided by the high permeability of the ferrite core), the electrical resistance of any primary winding on associated ferrite inductor is proportional to the plasma resistance near the core. Therefore, although all discharge currents path in plasma (penetrating two or more neighboring inductors) flow in parallel, they are transformed to associated primary windings that are connected to the power source electrically in series.

To explain the negative feedback mechanism that equalizes plasma density (due to cooperative mode of inductor operation) over a large area, let assume that for some reason (the proximity of the chamber wall or reduced gas density due to non-uniformity in the working gas flow) the plasma density coupled to one of core pair is some reduced. That would increase the primary winding resistance that increases the rf power deposited in the area of reduced plasma density, since in series circuit, the power redistribution is proportional to resistance. Thus, a reduction in a local plasma density leads to increase in the local rf power deposition that, in turn, trends to increase the local plasma density. For the same reason, this negative feedback not only automatically maintains the plasma uniformity over a large plasma area (without an external control system) but also prevents plasma density temporal instability typical for plasma processing reactors with molecular and electronegative gases.

Other objects, features and advantages will be apparent from the following detailed description of preferred embodiments taken in conjunction with the accompanying drawing in which:

### BRIEF DESCRIPTION OF THE DRAWINGS

FIG. 1 is a schematic cross-sectional view of the plasma reactor embodiment of the invention for volume plasma processing, in the plane of the plasma discharge path;

FIG. 2 is a three-dimensional view of such apparatus for volume plasma processing, according to the FIG. 1 embodiment, with a part removed for illustrating the interior of the plasma source;

FIG. 3 is the electrical circuit illustrating electrical connections of the inductors, resonant-matching circuit and RF power supply for the plasma source of the FIG. 1 embodiment;

FIG. 4 is a three-dimensional view of a further, multiple-stage plasma source embodiment with two inductor casings and three chamber compartments having cylindrical cross sections;

FIG. 5 is a schematic sectional view of another embodiment of the invention with the bottom chamber compartment functioning as a plasma processing chamber with a semiconductor wafer being processed;

FIG. 6 is a schematic sectional view of another embodiment plasma source of the invention with the bottom chamber compartment containing an ion extraction-acceleration structure;

FIG. 7 is a multi-inductor plasma source for uniform surface processing;

FIG. 7a is a schematic cross-sectional view;

FIG. 7b is a schematic plan view of the multi-inductor casing of the plasma source;

FIG. 8 is a plan view of the 18-inductor circular casing having two groups of inductors and showing primary winding connection;

FIG. 9 is a plan view of a circular casing with 6 peripheral inductors and an additional central inductor to provide radial component of the discharge current;

FIG. 10 is an embodiment of the invention as a linear plasma source with an ion extraction and acceleration means;

FIG. 11 is a sectional view of a linear plasma source with a strip inductor casing partially dividing the discharge chamber;

FIG. 11a shows the direction of the discharge current paths for inductors operating in cooperative mode;

FIG. 11b shows the direction of the discharge current paths for inductors operating in individual mode;

FIG. 12 is a sectional view of a plasma source for uniform plasma surface processing, having multiple of strip inductor casings;

FIG. 13 is two side sectional views of a plasma source having a casing with a single ferromagnetic inductor;

FIG. 13a is a view in the plane of discharge current path P (shown by arrow);

FIG. 13b is a view in the plane normal to discharge current path.

FIG. 14 is a large-scale inductive plasma source with a rotating discharge path, thereby able to operate from an industrial 3-phase ac power line;

FIG. 14a is a cross-sectional view of the source;

FIG. 14b is a plan view of the three-inductor casing showing connection of the primary windings to a 3-phase ac power line.

### DETAILED DESCRIPTION OF PREFERRED EMBODIMENTS

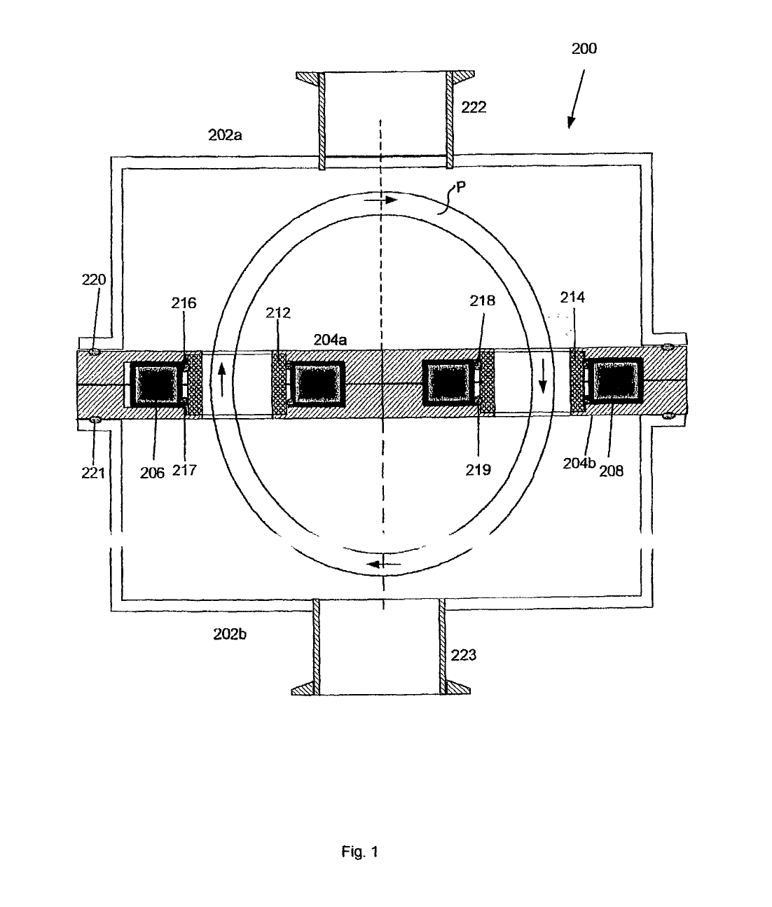

A schematic cross-sectional view of a basic embodiment of plasma reactor of the invention, is shown in FIG. 1 in the plane of the plasma discharge path P. It can be seen that the plasma source, which as a whole is designated by reference numeral 200, consists of a sealed vacuum chamber 202 divided by a flat inductor casing 204 with encapsulated toroidal ferromagnetic inductors 206 and 208. The inductors (that may be of ferrite material) are coplanar to each other and consist of a closed toroidal ferromagnetic (ferrite) cores and primary winding connected (directly or via LC circuit) to a RF power source (not shown here). Although only two inductors 206 and 208 are shown, the inductor casing may contain more than two ferromagnetic inductors. The inductors are hermetically sealed in the casing 204 with dielectric tubes 212 and 214 via elastomer gaskets 216-219. The dielectric insertion tubes 212 are and 214 needed to prevent the shortening the RF voltage induced by the inductors 206 and 208. The casing 204 is formed of two parts 204a and 204b between which the toroidal inductors 206 and 208 are sandwiched with elastic thermoconductive layers (such as rubber, resin or soft ceramic-based pads, not shown here). Two parts of the chamber, 202a and 202b are welded to, or sealed with the corresponding parts of the inductor casing 204a and 204b by the elastomer rings 220 and 221. The chamber has a gas inlet 222 and an outlet 223 for flowing of the working gas mixture.

The inductor casing 204, made of metal (such as aluminum) or a dielectric with high thermoconductivity, provides an effective heat transfer from ferromagnetic inductors 206 and 208 to the casing age and the chamber flanges. From there the heat is removed with a standard cooling means. For shown in FIG. 1 a rectangular chamber, the cooling of the inductor casing (and thus, encapsulated inductors) is provided by water flowing through hollow channels penetrating the casing (not shown here).

The chamber shape may be rectangular, cylindrical or any desirable shape and chamber compartments and inductor casing may be made of conductive or dielectric material, depending on the specific application of the plasma source.

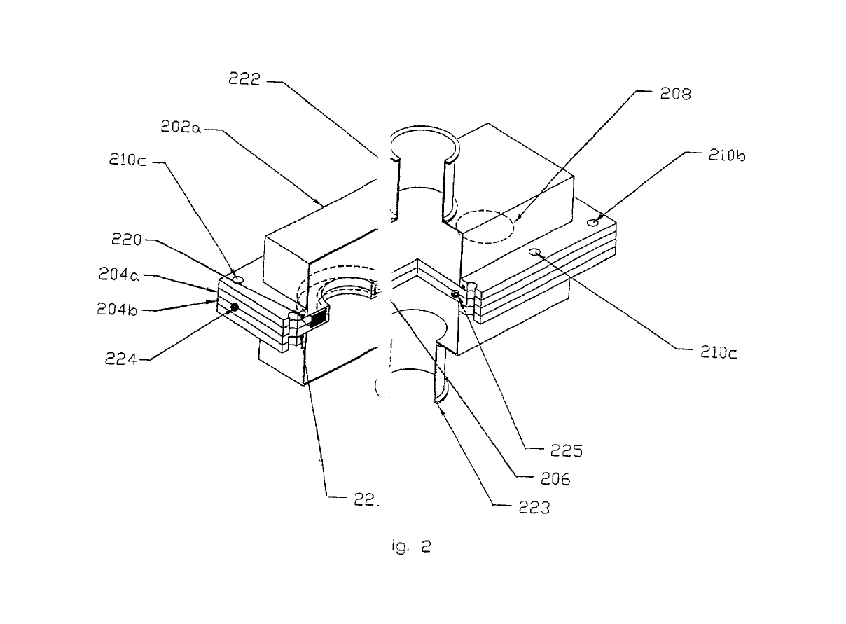

FIG. 2 shows a three-dimensional view of a rectangular plasma source of FIG. 1, with a part removed for illustrating the interior of the source. This view illustrate the position of the second toroidal inductor 208, which is shown by broken circular line, and hollow channels 224 and 225 for water cooling. Openings in the chamber flanges 210a, 210b, 210c are intended for bolting the half-chambers 202a and 202b with both parts of the casing 204a and 204b.

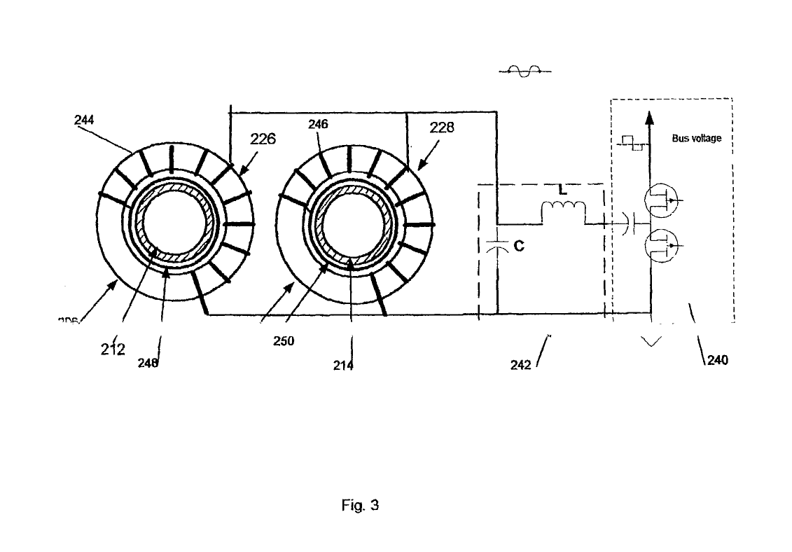

FIG. 3 shows electrical connections for the components of the plasma reactor of the invention. Each primary winding 226 and 228 of the respective inductors 206 and 208 are connected to a square wave RF power switching source 240 via a matching parallel resonant circuit 242 consisting of an inductor L and capacitor C. The windings 226 and 228 of adjacent inductors 206 and 208 are electrically connected in parallel with one end of each winding connected to the matching circuit 242, and other end connected to the common ground point as it shown in FIG. 3. The values of the capacitor C and the inductor L of the matching circuit 242 are chosen to operate at nearly resonant condition at the power source frequency, f≈(2πLC)⁻¹. The resonant matching circuit 242 is essential part of the plasma source of the invention performing several important functions. It matches the impedance of the primary windings 226 and 228 of the plasma source to the low output impedance of the rf power source 240. Plasma load (and that transformed to the primary windings) has a typically negative current-voltage characteristic, and for stable discharge operation, the desirable matching condition requires that output impedance of the matching circuit 242 to be larger than the resistance of the primary winding loaded with plasma. Shown in FIG. 3 the L-C matching circuit effectively ballasts the plasma source, making rf generator working as a current source. Energizing the inductors by the current source prevents the plasma distinguishing in the case of significant drop in the line voltage and/or changing in gas pressure.

L-C matching circuit 242 effectively filters out higher harmonics from square wave form generated by the rf source, resulting in cosine rf voltage on the primary winding. Filtering of high harmonics reduces power loss in the ferrite inductors and reduces electromagnetic interference produced by both, rf plasma source and rf power source, since inductor L connected to the output transistors of the rf power source 240 provides a “soft” switching mode.

Without plasma, the unloaded resonant matching circuit 242 provides resonant over voltage on the primary windings connected (directly or with additional starting windings 244 and 246) to the starting ring electrodes 248 and 250 (placed on external surface of the dielectric tubes 212 and 214) to make break-down of the working gas and transition to inductive (operational) mode, enhanced by simultaneous jump in inductive rf field along the circular discharge path. Thus, the ferrite inductors (that maintain plasma discharge in the steady state) together with the matching L-C circuit provide a self-starting feature of the plasma source of the invention, without a separate additional starting means in the prior art (for example, as in U.S. Pat. No. 6,150,628).

The discharge current path (designated as P in the FIG. 1 embodiment of the invention) has four parts that have different lengths and cross sections. Two short parts having relatively small cross sections are within the dielectric insertions tubes 212 and 214 and two relatively long parts with essentially larger cross sections are within the two compartments of the discharge chamber 202a and 202b. According to the basic property of gas discharge plasma, the electric field needed to maintain a steady state discharge, is smaller for a larger discharge cross section. Therefore, the increase in the discharge cross section of the longest part of the discharge path (in the chamber compartments) results in reduction of the discharge voltage (emf) comparing to that in devices of the prior art [U.S. Pat. Nos. 4,431,898; 5,290,382; and 6,150,628] teaching a constant discharge cross section limited by a thin toroidal chamber able to penetrate ferrite core transformer. Since ferrite loss is a sharp function of the induced by ferrite inductor emf, the reduction of the discharge voltage significantly reduces ferrite core losses or/and reduces the amount of the ferrite material needed to maintain the discharge plasma.

Increasing of discharge cross section (for the longest part of the discharge path in the chamber compartments) also leads to increasing of the discharge volume and, simultaneously, (due to reduction of plasma diffusion to the chamber wall) to increasing of the plasma density. As a result, the plasma source of the invention has much more total plasma electrons participated in chemical reactions and, thus, has much higher plasma reaction productivity per unit of rf power and per ferrite core size than the volume plasma processing devices of the prior art [U.S. Pat. Nos. 4,431,898; 5,290,382; and 6,150,628] teaching thin toroidal discharge chambers.

Contrary to the prior art plasma sources with toroidal chambers, the ferrite core inductors in the plasma source of the present invention are surrounded by the discharge chamber compartments and the total volume of the discharge chamber filed with plasma is nearly equal to the exterior size of the whole device. Increase in the inner chamber surface area leads to reduction of the chamber wall loading by plasma and by active species, resulting in increasing its durability and in simplification of the chamber cooling.

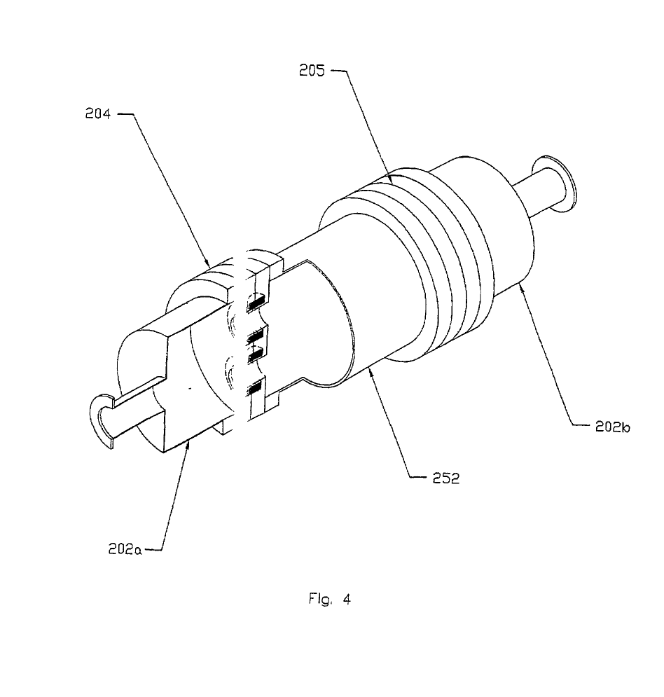

FIG. 4 shows a multiple-stage plasma source with two or more inductor casings dividing the plasma chamber on three or more compartments that can be built according to present invention. As an example, three-chamber compartment (202a, 252 and 202b) with two identical inductor casings 204 and 205 are shown in FIG. 4. Such device can provide a larger plasma volume and thus, larger the reaction rate comparing to a single inductor casing and two compartments, or/and allows for multi-stage diversified plasma reactions in different compartments by supplying different rf power to each inductor casings or/and by having different gas mixture in each compartments. Thus, stacking of number of inductor casings and chamber compartments with programmable rf power supply to each inductor casing, one can build plasma sources able to process simultaneously several plasma-chemical reactions.

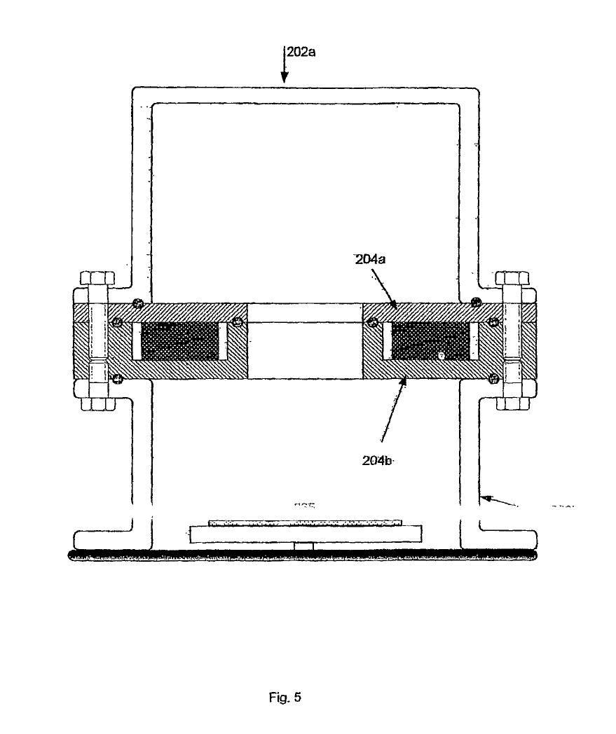

The plasma reactor embodiments of the invention described above, usable for volume processing, can also be used as autonomous sources of plasma for variety of applications. FIG. 5 shows a plasma reactor embodiment of the invention, in which the lower chamber compartment 202b has on the bottom the plasma-processing wafer 265. Similarly, this plasma source can be used as an ion source when an ion extraction-acceleration structure 254 is attached to the bottom of the second chamber compartment (202b), as it shown in FIG. 6.

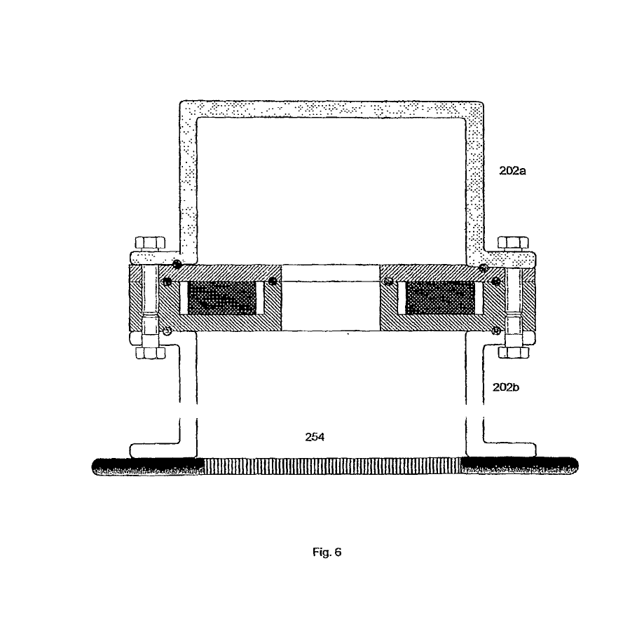

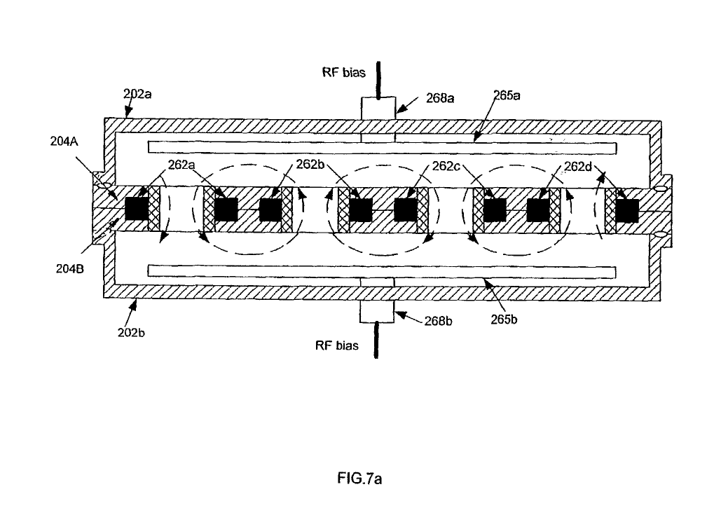

FIG. 7 is a schematic diagram of another embodiment of the invention suitable for large surface uniform plasma processing of large wafers and display panels. This plasma source utilizes the plasma uniformity self-control feature of the present invention (discussed above) in an array of the ferrite inductors built into a flat inductor casing.

FIG. 7a shows a cross sectional view plasma reactor and FIG. 7b shows a plan view of the open inductor casing with six inductors 262a, 262b, 262c and so on, and having their associated primary windings connected in series. The plasma source shown in FIG. 7a consists of two chamber compartments 202a and 202b with low aspect ratio (height to diameter), divided the inductor casing that consist of two parts 204a and 204b and encapsulates plurality of ferrite core inductors 262a, 262b, 262c and so on. Each of compartments 202a and 202b may have a processing wafer 265a and 265b with corresponding chucks 268a and 268b.

The primary windings 266a, 266b, 266c and so on, of all inductors are connected in series to the power source (not shown here) via a matching L-C circuit shown in FIG. 3. The winding connection and their arrangement on the inductor cores are made in such a way, that direction of emf in neighboring inductors are opposite, thus providing common circular, closed path discharge currents penetrating neighboring toroidal inductors. The directions of the discharge current paths in the plan of inductor casing with six inductors (for some fixed moment of time) are shown in FIG. 7b by the arrows. Since discharge currents oscillate with RF frequency, the direction of the discharge paths in the next half period would be opposite to that shown in FIG. 7b.

Due to the common casing 204 for all inductors and the alternative directions of emf in neighboring inductors, a considerable part of discharge path (from one to other inductor holes) goes along flat surface of the casing, thus spreading the discharge over large area of the casings 204a and 204b and chamber compartments 202a and 202b, thus contributing to plasma uniformity. Common discharge paths of the neighboring inductors, provides a mutual electromagnetic coupling between the inductors making them interacting each with other. Together with negative feedback provided by the connection of all inductors in series, this interaction of the neighboring inductors provides spatially uniform and temporal stable operation of the plasma source of the invention.

The structure and way of operation of the invented plasma source with interactive ferrite inductors (inductor cluster) is essentially differs from ferrite inductor array of the prior art (U.S. Pat. No. 5,998,933) where there is no a flat inductor casing effectively cooling ferrite inductors and spreading the plasma over a large surface area. According to U.S. Pat. No. 5,998,933, discharge current goes, in the shortest current path, around of each individual ferrite inductor, (individual operating mode) without spreading the discharge current paths over area in the plan of the inductor array. The inductor array described in U.S. Pat. 5,998,933 has no interaction between inductors and there is no means that could maintain the stable and uniform operation of each of inductors.

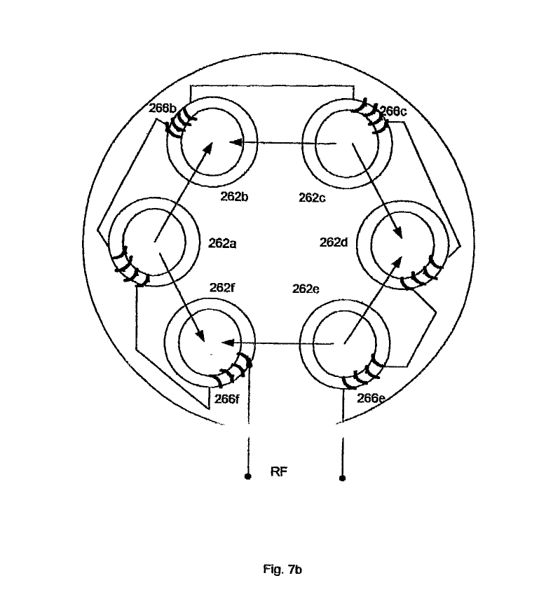

Different numbers of ferrite core inductors can be arranged in the casing, the more inductors the more plasma uniformity or/and over the more area uniform plasma can be produced. The inductors can be arranged in azimuthal (as shown in FIG. 7b), in square and in hexagonal symmetry or in any desirable configuration, depending of chamber and processing wafer geometry. The inductors can be arranged in few groups (as it shown in FIG. 8) with primary windings in each group connected in series, while having separate terminals for each groups (A and B). The inductor groups can be connected to rf power source in series, or/and in the way providing control of the rf power ratio delivered to each group of inductors, thus to control plasma density distribution in the radial direction.

The inductors in each group should be of the same geometry, ferrite material and number of turns of the primary winding, although they could be different in different groups. Thus, for enhancement of the plasma uniformity, the last peripheral group of the inductors may have some larger number of turns of their primary windings than those in inner circle groups. That would lead to a larger rf power deposition per inductor and to enhanced ionization on the peripheral plasma, thus to compensate the natural plasma density depletion near the chamber wall. Arranging different power (or different rf current) in the to each concentric group of inductors, one can control the plasma spatial distribution in the source of the invention.

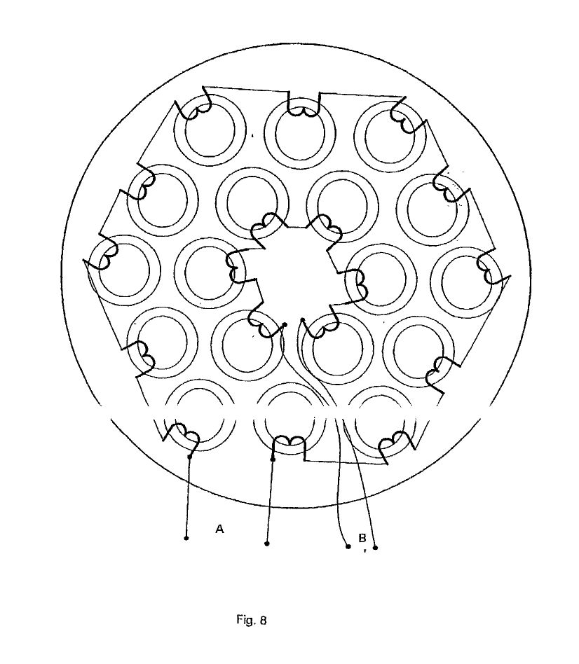

To improve plasma uniformity in the central part of the plasma source is to place an additional inductor 266g in the center of the inductor casing as shown in FIG. 9. To achieve a symmetrical operation of this additional inductor and to make its induced discharge current flowing through surrounding inductors in the nearest inductor group (as it shown in FIG. 9 by radial arrows) without violation its azimuthal symmetry, the rf current driving the central inductor is about 90 degree shifted reference to the current in the rest of inductors. The phase shift of the central inductor is achieved by connection its primary winding to rf power source via variable capacitor 270 that allows for adjusting of the plasma uniformity in the center of the chamber. Being 90 degree shifted, the current induced by the central inductor does not interfere with discharge current of the surrounding inductor groups.

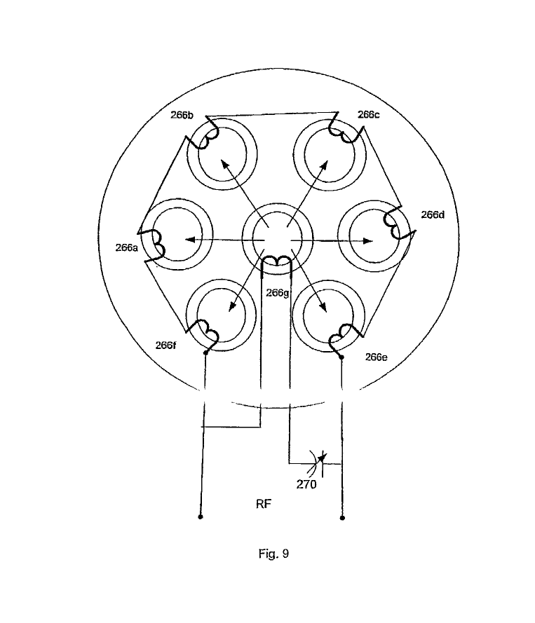

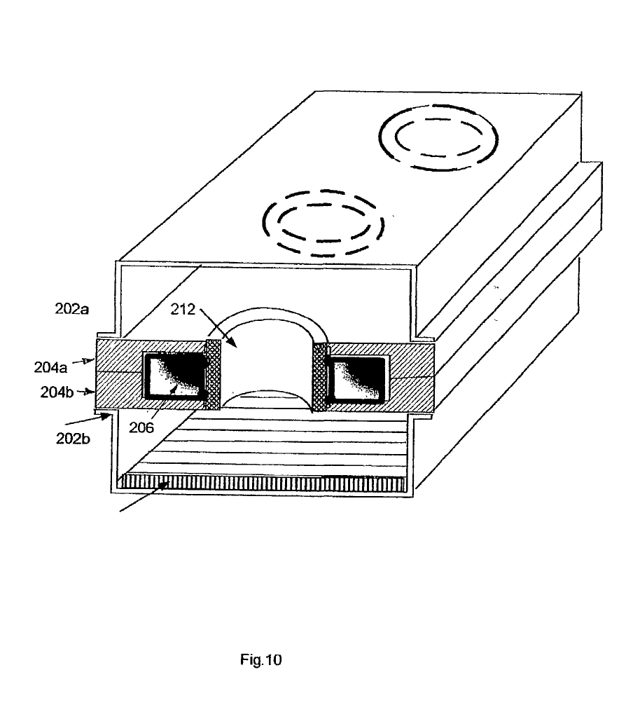

FIG. 10 shows a linear plasma source, designed according to present invention, with all inductors placed along strait line. Such an embodiment of the invention allows for construction of linear ion source when an ion extraction and accelerating means 254 are installed at the open end of the chamber compartment 202b.

Another embodiment of the present invention, utilizing flat inductor casing encapsulating plurality of the inductors, as a linear plasma source, is shown in FIG. 11. Here the casing 205 with inductors is attached to the bottom of a narrow rectangular chamber 203, leaving a gap between the casing and open end of the chamber. Different way of discharge current path (shown in FIG. 11 by arrows) can be organized in the source, depending on orientation of electromotive forces (emf) induced by the each ferrite inductor. When the electromotive forces induced by the neighboring inductors have opposite directions, the discharge current paths go along the casing, as it is shown in FIG. 11a by arrows. In this case, due to plasma diffusion from spaces at both sides of the casing, in the direction normal to discharge paths, to the gap between the casing and the chamber opening, the space in the gap at the chamber opening is filled with plasma.

When the electromotive forces induced by the neighboring inductors encapsulated in the strip casing have the same directions, the discharge current path through each inductor flows in direction normal to the inductor casing as it is shown in FIG. 11b by arrows. In this case, each inductor operates individually, having its induced discharge current penetrating only the very same inductor. The discharge current also penetrates the gap near chamber opening, enhancing plasma density there.

Series connection of the primary windings in al inductors to a power source in the linear plasma sources shown in FIG. 11a and FIG. 11b, provide the plasma uniformity self-control feature, discussed above for the invention embodiment shown in FIG. 7a and 7b. The open end of the chamber 203 can be adjusted to the processing wafer or to an ion extraction and acceleration means, similarly to that shown in FIG. 10.

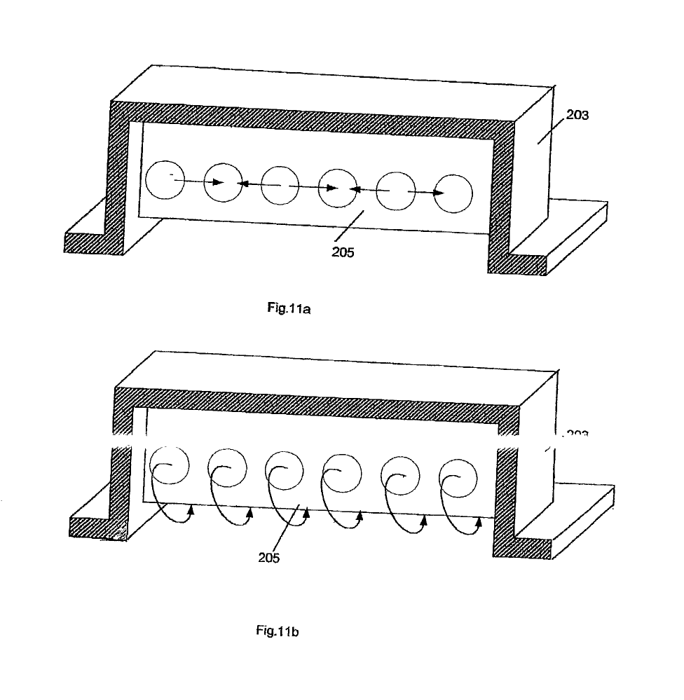

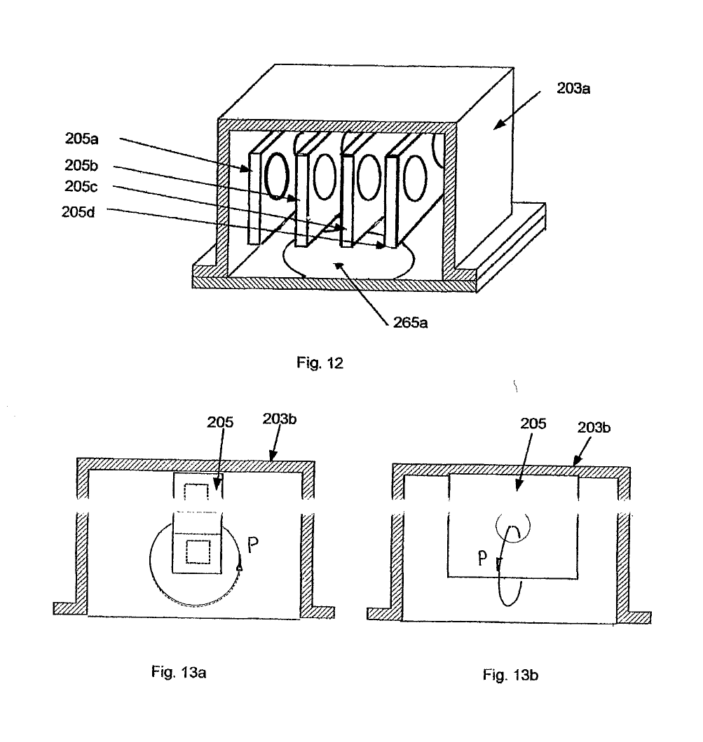

FIG. 12 is a schematic diagram of another embodiment of the invention suitable for large surface uniform plasma processing of large wafers and display panels. This plasma source utilizes two or more strip inductor casings 205a, 205b, 205c, 205d (similar to those shown in FIGS. 11a and 11b) installed in the chamber 203a with a processed wafer 265a. The plasma uniformity self-control feature in this plasma source is provided by the series connection of the primary windings of all casings to a power source, as was discussed above.

The plasma source of the invention having of inductor casing partially dividing the discharge chamber 203b (similarly to those shown in FIGS. 11 and 12) can be made with a plurality of casings, each of them having just one ferromagnetic inductor. A similar plasma sources can be made using just one ferromagnetic inductor encapsulated into casing 205 adjusted to the inner surface of the discharge chamber 203b as it shown in FIG. 13.

The described here different embodiments of plasma sources of the invention with a flat inductor casing (completely or partially dividing the discharge chamber), both, for plasma volume processing and for uniform surface processing can have size from few cm up to few meters and operate at rf or ac power from tens W to many kW. These sources can effectively operate in a wide range of gas pressure (from fraction of mTorr to tens of Torr) and frequency range from tens of Hz to few MHz.

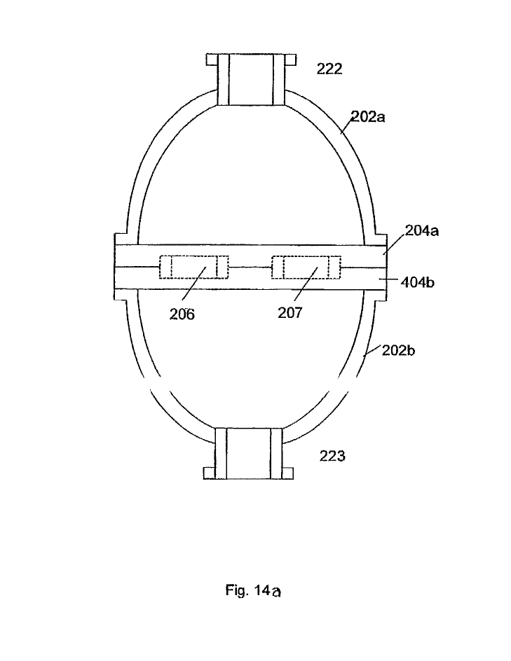

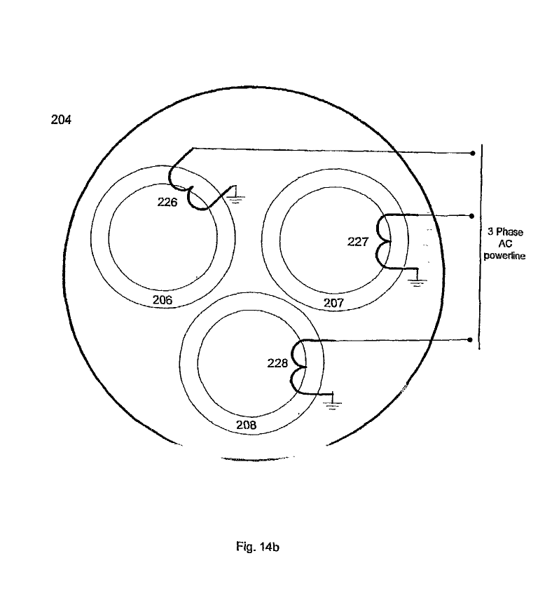

Another embodiment of the present invention (shown in FIGS. 14a and 14b) is an inductive plasma source able to operate at extremely low frequency. Having three inductors made of transformer steel, symmetrically built into a flat inductor casing and with their primary windings connected to a 3-ac power source, a continuous rotating plasma can be maintained in both chamber compartments. With 3-phase power source, the phase of the current flowing through each two inductors is shifted 120-degrees. Therefore, the total discharge current in this source at any moment is not zero. The discharge current flowing through the inductor casing and in both chamber compartments is the sum of 120-degrees shifted currents, resulting in wave of rotating current in the plane parallel to the inductor casing. The frequency of rotation is equal to the frequency of the power source. The absence of the zero-crossing in the total discharge current in this plasma source make it possible to use very low frequency to maintain discharge. A conventional (single-phase) inductive discharge is impossible to maintain continuously at frequency essentially lower than characteristic frequency of plasma relaxation, due to discharge extinguishing at the zero crossing of the discharge current. This plasma source is able to generate plasma in an extra-large volume using very low frequency, up to industrial range of 400; 60 and 50 Hz, from industrial ac power line (directly or via some ballasting and controlling means) with no need of RF power converter (generator). That significantly simplifies plasma production and reduces cost of the large volume plasma source for abatement, sterilization, ion implantation and similar applications.

Although the invention has been described with reference to specific embodiments, it is understood that the invention is not limited by these embodiments and that any changes and modifications are possible, provided they do not depart from the scope of the attached patent claims. For example, ferrite cores and discharge chamber may have shapes different from those shown in the drawings and can be square, oval, round, etc. For better inductor cooling, each inductor can be made of few ferrite cores divided by heat removing metal plates and stacked onto each other. The chambers and casings can be made of different materials, e.g., from thermo conductive ceramics. Different cooling arrangements and different sealing means could be used to build the plasma source. The planar inductor casing can be designed with different number of ferrite core or transformer steel inductor cores, and even with a single inductor. In the later case, an additional opening in the inductor casing or a gap between the casing and chamber is needed for a discharge current flow. The proposed plasma sources can be also used as an autonomous source of plasma for variety of applications.

Significant reduction of the driving frequency, when using inductors with closed ferromagnetic cores, down to hundreds of kHz and even to tens of Hz, makes the inductance and capacitance of the wires connecting the ferromagnetic inductors to be negligible, thus eliminating both, the capacitive coupling with plasma and the transmission line effect causing contamination and plasma non-uniformity in conventional ICP operating at 13.56 MHz.

1. An inductive plasma source for volume and surface plasma processing comprising:
a) means defining a plasma chamber with means for plasma containing and maintenance at appropriate power and working gas pressure,
b) dividing means for subdividing the chamber into at least two cooperating chamber compartments, and constructed and arranged for a closed discharge current path penetrating both chamber compartments via openings in the dividing means, said dividing means being thermoconductively coupled to a wall of the chamber.
c) said dividing means including an essentially flat wall portion between the compartments, encapsulating at least one closed magnetic path ferromagnetic inductor having an associated primary winding connected to an alternating electrical power source, and the dividing means having at least two openings transparent to induced discharge current, and
d) a plasma ignition electrode connected to the primary winding of said inductor, to initiate the discharge in said plasma source.

2. The plasma source of claim 1, wherein the inductors form a transformer where their primary windings function as primary windings and discharge current paths in the plasma function as secondary windings.

3. The plasma source of either of claims 1 or 2, wherein the power supply comprises an rf power source.

4. The plasma source of either of claims 1 or 2, wherein the power-supply comprises an industrial ac power line.

5. The plasma source of any of claims 1-4 with the ferromagnetic inductor having additional step-up windings for obtaining appropriate starting voltage to initiate the working gas break-down.

6. The plasma source of any claims of 1-5, wherein the power supply includes a parallel resonant matching circuit to stabilize the plasma and to provide an over-voltage on the primary and the step-up windings to initiate break-down and to start the plasma.

7. The plasma source of any claims of 1-6, having multiple of chamber compartments divided by at least two said dividing means, each incorporating at least one ferromagnetic inductor and having at least two openings transparent to induced discharge current.

8. The plasma source of any of claims 1-7, where at least one chamber compartment is opened for connection to an external plasma treatment tool for surface plasma processing.

9. The plasma source of any of claims 1-8, where at least one chamber compartment is opened for connection to an ion extraction and accelerating means, thereby, to form an ion source.

10. The plasma source of any of claims 1-9, having a flat divider with a coplanar, symmetrically encapsulated plurality of ferromagnetic inductors whose primary windings are connected in series to an rf power supply and are arranged in a such way, that neighboring inductors are magnetically coupled by common discharge currents penetrating at least two neighboring inductors.

11. The plasma source of claim 10, where the plurality of inductors are arranged in groups concentric each other and able to be driven by different rf current, thereby allowing for control of the plasma uniformity over a large processing area.

12. The plasma source of either of claims 10 or 11, further including a central inductor having its primary winding connected to an rf power source via a variable capacitor, thereby providing the plasma uniformity control.

13. The plasma source of either of claims 10 or 11, where the inductors are arranged in straight line to form a linear plasma source.

14. The plasma source of any of claims 1-11 and 13 having at least one inductor casing partially dividing the chamber.

15. The plasma source of any of claims 1-10, 13 and 14 having at least one inductor casing attached to the interior of the discharge chamber and comprising a single ferromagnetic inductor.

16. The plasma source of any of claims 1, 2 and 4-9, having said casing encapsulating at least one set of three inductors with their primary windings correspondingly connected to three terminals of industrial 3-phase ac power line, to thereby maintain a continuous rotated discharge current in each chamber compartment.

17. A method of plasma generation comprising the steps of:
(a) inducing a closed discharge path between adjacent plasma zones via a divider with openings,
(b) at least one of said openings containing an encapsulated closed magnetic path ferromagnetic inductors; and
(c) cooling the inductors, and conducting heat from the inductors via the divider to a chamber wall.

18. A method of providing plasma uniformity in an inductive plasma source with multiple arrayed inductors converting currents in the plasma to corresponding series currents in primary windings of inductors,
by connecting said primary windings in series to a power source and arranging the primary windings to induce opposite directed plasma currents in the neighboring ones of the inductors.

19. A method of initiation of inductive discharge maintained by a ferromagnetic inductor, comprising auto-synchronization of gas break-down high voltage with maximal electromotive force developed by said inductor, via connection of a starting electrode to the primary winding of said inductor.

20. A method of providing non-disruptive plasma in an inductive discharge, able to operate from low frequency power source, comprising the steps of maintaining 120 degree shifted circulating discharge paths by connecting the primary windings of three cooperating ferromagnetic inductors to corresponding three terminals of a 3-phase alternate current industrial power line.
